(19) United States
(12) Patent Application Publication
(10) Pub. No.: US 2007/0049310 A1
(43) Pub. Date: Mar. 1, 2007

(54) Data storage device with wireless interface for autonomous operation

(75) Inventors: James T. Hagler, Carlsbad, CA (US); Fred C. Thomas III, Ogden, UT (US)

Correspondence Address: PROCOPIO, CORY, HARGREAVES & SAVITCH LLP, 530 B STREET, SUITE 2100, SAN DIEGO, CA, 92101, US

(73) Assignee: Iomega Corporation

(21) Appl. No.: 11/215,567

(22) Filed: Aug. 29, 2005

(51) Int. Cl. H04H 7/00; H04L 12/58; H04B 7/00

(52) U.S. Cl. 455/514; 455/412.1

(57) ABSTRACT

A wireless interface is included in an electronic product for connecting the product to a remote storage device. When the memory in the electronic product reaches a threshold level, the wireless interface initiates a connection to the remote storage device. Once the connection is established, the contents of the electronic products memory are transferred via the wireless interface to the remote storage device. After the transfer is completed, the memory of the electronic product can then be safely cleared for further use.

### TECHNICAL FIELD

This invention relates to data storage devices, and more particularly to a wireless interface for transferring information stored on the data storage devices.

### BACKGROUND

Over the past several years, consumer electronic devices have used internal or removable memory to store data. An example of this is a digital camera that uses removable flash memory cards such as a CompactFlash card or a SD flash card. These memory cards can be expensive, running over $100 for one gigabyte of storage.

When a user takes digital photos, those photos are stored on the flash memory card. In the case of a digital camera, as the user takes more photos, the memory cards rapidly reach their maximum capacity. Once the memory cards are full, the user must either clear the card by transferring all the photos to another storage device such as a computer or put in another memory card. As stated above, the memory cards are expensive, so a user would typically like to minimize the number or memory cards needed. Further, if one is outside taking photos, it is unlikely they have a computer or some other system handy to easily transfer the contents of the memory cards.

As the cost of wireless communication technology comes down, it is becoming more feasible to integrate wireless technology within consumer electronic devices. Recently, it has become common to incorporate a digital camera in a cellular telephone. The technology has become affordable to put both of these once costly items into a single, reasonably priced consumer electronic device. However, typically the devices have been focused on primarily the cellular telephone, with the digital camera portion being of low resolution and quality.

What is needed is a system of automatically transferring the contents of the memory in a consumer electronic device whenever the memory approaches its maximum capacity. This system should be transparent to the user and be able to function regardless of whether the user has ready access to a computer or other device that may be use to achieve the transfer.

### SUMMARY

A wireless interface is included in an electronic product for connecting the product to a remote storage device. When the memory in the electronic product reaches a threshold level, the wireless interface initiates a connection to the remote storage device. Once the connection is established, the contents of the electronic products memory are transferred via the wireless interface to the remote storage device. After the transfer is completed, the memory of the electronic product can then be safely cleared for further use.

### DESCRIPTION OF DRAWINGS

These and other features and advantages of the invention will become more apparent upon reading the following detailed description and upon reference to the accompanying drawings.

FIG. 1 is a block diagram illustrating an electronic product having memory and a wireless interface and a remote storage device according to the present invention.

FIG. 2 illustrates a process for automatically transferring the contents of the memory in the electronic product to the remote storage device.

### DETAILED DESCRIPTION

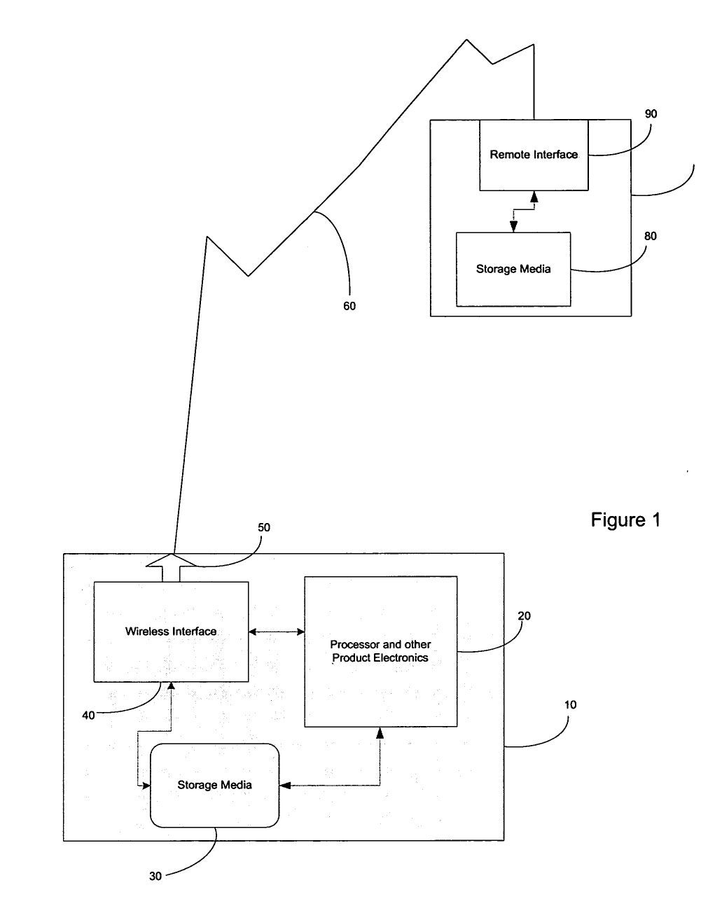

FIG. 1 is a block diagram illustrating an electronic product 10 having a storage media 30 and a wireless interface 40 and a remote storage device 70 according to the present invention. The electronic product 10 can be any portable electronic product that uses memory. Some examples of such a product include a digital camera, a camcorder, a personal digital assistant, a portable game system, a portable music or movie player, or any other device that may need memory capabilities. The electronic product 10 includes a processor and other product electronics 20, storage media 30, the wireless interface 40, and optionally an antenna 50.

The processor and other product electronics 20 typically includes all necessary electronics for controlling the operation of the electronic product 10. For example, in a digital camera, the processor and other product electronics 20 may include an image sensor such as a charge coupled device (CCD) and the processor necessary to control all the functions of the camera. When an image is captured by the processor and other product electronics 10, it may be transferred to the storage media 30.

The storage media 30 may be any form of memory device, embedded or removable. Some examples storage media used in consumer electronic products include flash memory cards (such as CompactFlash, SD cards, Smartmedia cards, MemoryStick cards), microdrives, optical disks, hard disks, and computer RAM. Essentially anything that is capable of storing information may be used as the storage media 30.

The wireless interface 40 is connected to the storage media 30 and the processor 20. The wireless interface 40 may include an antenna 50. In one embodiment, the wireless interface 40 only needs to be able to transmit information, although a two-way (transmit and receive) interface may be used. Although the wireless interface 40 may use any type of wireless technology, including cellular, wireless LAN (802.11), or Bluetooth, the preferred embodiment uses cellular technology to increase the range of coverage. Of course, the specific type of wireless technology used is not critical to the invention.

There are many different types of cellular technology available to transmit data from the wireless interface 40. Some examples of these include Code Division Multiple Access (CDMA), Enhanced Data rate for GSM Evolution (EDGE), General Packet Radio Services (GPRS), Global System for Mobile Communications (GSM), Personal Communications Service (PCS), Time Division Multiple Access (TDMA), Universal Mobile Telephone Standard (UMTS) and other systems. The specifics are each of these technologies are well known and beyond the scope of the present invention.

The remote storage device 70 includes storage media 80 and a remote interface 90. The storage media 80 may include any type of device that stores data, such as a magnetic hard drive, an optical disk, or an online storage service. The remote interface 90 may be a wireless interface that is capable of direct communication with the wireless interface 40 of the electronic product 10, or may be a communications interface that receives data directly such as an Internet connection, a serial interface, or an Ethernet connection.

In operation, the electronic product 10 reaches a trigger point which causes the processor 20 to initiate a connection 60 from the wireless interface 40. The wireless interface 40 establishes a connection using a predetermined protocol. The wireless interface 40 may make a direct connection with the remote interface 90, or the wireless interface 40 may make a connection with to a network interface (not shown) which then connects to the remote interface 90. Either way the wireless interface 40 established a connection 60, direct or indirect, with the remote interface 90. If additional security is desired, the connection 60 may use encryption or other security features. Once the connection 60 is established, the contents of the storage media 30 are transferred through the wireless interface 40, over the connection 60, to the remote storage device 70 via the remote interface 90.

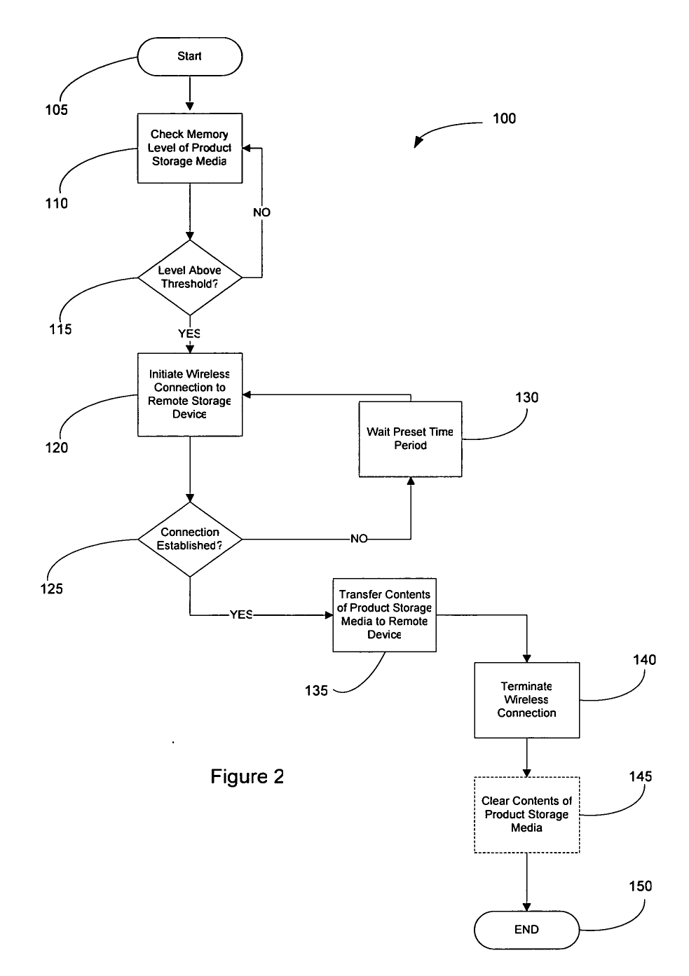

FIG. 2 illustrates a process 100 for automatically transferring the contents of the storage media 30 in the electronic product 10 to the remote storage device 70. The process 100 begins in a START block 105. Proceeding to block 110, the process 100 checks the memory level of the storage media 30 to determine if a data transfer is necessary. The memory level at which the data transfer is deemed necessary may be a predetermined threshold or may be defined by the user. For example, a threshold of 70% of maximum capacity may be set so that a data transfer will be triggered when only 30% of storage capacity remains.

Proceeding to block 115, the process compares the measured memory level against the set threshold to see if the trigger has been reached. If the memory level is below the preset threshold, the process 100 proceeds along the NO branch back to block 110 to continue to monitor memory usage. Once the memory usage exceeds the threshold, the process 100 proceeds along the YES branch to block 120.

In block 120, the wireless interface 40 initiates a connection 60 to the remote storage device 70. As stated above, this connection 60 may be accomplished using a cellular interface or any other wireless technology available. The specific wireless technology used to achieve the interface may be variable and is not critical to the present invention.

Proceeding to block 125, the wireless interface 40 checks to determine whether a connection 60 with the remote storage device has been established. If the connection 60 is not established, it may be for a variety of factors. These may include being out of wireless range of any communication center or the remote storage device 70 being disabled or busy. If the connection 60 is not established, the process 100 proceeds along the NO branch to block 130. In block 130, the wireless interface 40 waits for a preset period of time, and then returns to block 120 to reattempt establishing the connection 60.

Returning to block 125, once a connection 60 is established, the process 100 proceeds along a YES branch to block 135. In block 135, the process 100 transfers the contents of the storage media 30 to the remote storage device 70. The process 100 may be set to transfer any or all of the contents of the storage media 30 once the connection 60 is established.

After the contents of the storage media 30 is transferred, the process 100 proceeds to block 140, where the connection 60 between the wireless interface 40 and the remote storage device 70 is terminated. The process 100 may then proceed to an optional block 145. In this optional step, the contents of the storage media 30 are deleted. Alternatively, the electronic product may simply inform the user that the contents of the storage media 30 have been successfully transferred so that the user may decide to manually delete the information from the storage media 30. The process 100 then terminates in END block 150.

Numerous variations and modifications of the invention will become readily apparent to those skilled in the art. Accordingly, the invention may be embodied in other specific forms without departing from its spirit or essential characteristics.

What is claimed is:

1. An electronic device comprising:
storage media for storing data in the electronic device;
a wireless communication interface; and
a processor which monitors contents of the storage media, wherein upon the storage media reaching a preset capacity the processor automatically initiates a connection from the wireless communication interface to transfer the contents from the storage media.

2. The electronic device of claim 1, wherein the wireless communication interface connects with a remote storage device.

3. The electronic device of claim 2, wherein the contents of the storage media is transferred to the remote storage device.

4. The electronic device of claim 1, wherein the wireless communication interface is a cellular interface.

5. The electronic device of claim 1, wherein the wireless communication interface is a Bluetooth interface.

6. The electronic device of claim 1, wherein the wireless communication interface is a wireless LAN interface.

7. The electronic device of claim 1, wherein the storage media is a flash memory card.

8. The electronic device of claim 1, wherein the electronic device is selected from a group consisting of: a digital camera, a camcorder, a personal digital assistant, a portable game system, a portable music player and a portable movie player.

9. A method of managing memory in an electronic device comprising:
determining contents of the memory have exceeded a predetermined level;
automatically establishing a wireless connection between the electronic device and a remote storage device; and
transferring at least a portion of the contents of the memory to the remote storage device.

10. The method of claim 9, further comprising deleting the contents of the memory that is transferred to the remote storage device.

11. The method of claim 9, further comprising informing a user the transfer is complete.

12. The method of claim 9, further comprising waiting a predetermined time period if establishing the wireless connection is unsuccessful.

13. The method of claim 12, further comprising reattempting to establish the wireless connection.

14. The method of claim 9, wherein the wireless connection is a cellular connection.

15. The method of claim 9, wherein the wireless connection is a Bluetooth connection.

16. The method of claim 9, wherein the wireless connection is a wireless LAN connection.

17. The method of claim 9, wherein the memory is a flash memory card.

18. The method of claim 9, wherein the electronic device is selected from a group consisting of: a digital camera, a camcorder, a personal digital assistant, a portable game system, a portable music player and a portable movie player.
